(19) United States
(12) Patent Application Publication
(10) Pub. No.: US 2009/0040450 A1
(43) Pub. Date: Feb. 12, 2009

(54) CIRCUIT BOARD, A LIQUID CRYSTAL DISPLAY MODULE HAVING THE SAME, AND A DISPLAY DEVICE HAVING THE SAME

(75) Inventor: Hiroaki Nakaminami, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/162,810

(22) PCT Filed: Nov. 15, 2006
(86) PCT No.: PCT/JP2006/322709

§ 371 Date: Jul. 31, 2008

(30) Foreign Application Priority Data
Feb. 10, 2006 (JP) 2006-033626

(51) Int. Cl. G02F 1/1343; H01R 9/00

(52) U.S. Cl. 349/152; 361/822

(57) ABSTRACT

A circuit board capable of preventing driver ICs and electronic and electrical components from being affected by static electricity, a liquid crystal display module having the same, and a display device having the same. The liquid crystal display module includes a liquid crystal display panel, gate side common circuit boards including FPC connector bonding lands placed at both ends in longitudinal directions of the gate side common circuit boards, and source side common circuit boards, wherein the FPC connector bonding lands adjacent to the source side common circuit boards are mounted with FPC connectors and are electrically connected with the source side common circuit boards, and surfaces of the FPC connector bonding lands placed at the other ends are covered with an electrical insulating coating.

### BACKGROUND OF THE INVENTION

1. Field of the Invention

The present invention relates to a circuit board, a liquid crystal display module having the same, and a display device having the same, and more specifically relates to a circuit board capable of preventing electronic and electrical components from being damaged by static electricity, a liquid crystal display module having the same, and a display device having the same.

2. Description of the Related Art

An assembly is sometimes made up of a liquid crystal display panel, TCPs and FPCs incorporating driver ICs for driving the liquid crystal display panel and bonded to the liquid crystal display panel, and circuit boards bonded to the TCPs and FPCs so as to make transmissions of predetermined electric signals and power thereto. A specific example of the liquid crystal display panel includes a liquid crystal display panel to one edge portion of which TCPs incorporating scanning line electrode drivers are bonded. The scanning line electrode drivers generate pulse voltages based on incoming control signals, and apply the generated pulse voltages to gate electrodes of thin film transistors via scanning lines in the liquid crystal display panel.

Incidentally, accompanied by recent increases in the size of a liquid crystal display panel, the length of scanning lines in the liquid crystal display panel increases. Accordingly, if the liquid crystal display panel is arranged such that pulse voltages are fed from one edge portion of the liquid crystal display panel (i.e., from one end of the scanning line), which is generally one of shorter edge portions of the liquid crystal display panel, a waveform of the fed pulse voltages is sometimes distorted. In order to prevent such waveform distortion, TCPs incorporating scanning line electrode drivers are sometimes provided at two parallel edge portions of the large liquid crystal display panel, and pulse voltages which are applied to drive gate electrodes are fed from both ends of the scanning lines.

FIG. 6 is an external perspective view schematically showing the structure of a conventional assembly in which TCPs are bonded to each of two parallel shorter edge portions of a liquid crystal display panel. As shown in FIG. 6, an assembly 9 includes a liquid crystal display panel 91, a plurality of TCPs 94 and TCPs 95 each incorporating a driver IC (a scanning line electrode driver 941 or a signal line electrode driver 951), and circuit boards 92 and circuit boards 93 capable of distributing electric signals and power to the TCPs 94 and TCPs 95, respectively.

The plurality of TCPs 94, each incorporating the scanning line electrode driver 941, are bonded to parallel shorter edge portions of the liquid crystal display panel 91. Generally, the TCPs 94 at one shorter edge portion of the liquid crystal display panel 91 are bonded to one circuit board 92 (hereinafter, the circuit board 92 is referred to as the “gate side common circuit board 92” for the sake of illustration). Meanwhile, the plurality of TCPs 95, each incorporating the signal line electrode driver 951, are bonded to one of longer edge portions of the liquid crystal display panel 91. Generally, the TCPs 95 are bonded to one or a few circuit boards 93 (hereinafter, the circuit board 93 is referred to as the “source side common circuit board 93” for the sake of illustration).

The source side common circuit boards 93 are connected with an external control circuit board (not shown) and other external members by FPCs 96 and other members, so that the source side common circuit boards 93 can receive transmissions of predetermined incoming electric signals and power, and distribute the received predetermined electric signals and power to each of the TCPs 95. In addition, the source side common circuit boards 93 and the gate side common circuit boards 92 are connected with each other by FPCs 97 and other members, so that the gate side common circuit boards 92 can receive the transmissions of the predetermined incoming electric signals and power via the source side common circuit boards 93, and distribute the received predetermined electric signals and power to each of the TCPs 94.

Since the assembly 9 is arranged such that pulse voltages are fed from both ends of scanning lines, the gate side common circuit boards 92 need to be provided at both of the parallel shorter edge portions of the liquid crystal display panel 91. Due to this, the number of components of the assembly 9 increases, which could cause an increase in production cost and an increase in product prices of the assembly 9. In order to solve this problem, the gate side common circuit boards 92 which are the same in structure are sometimes provided at both of the parallel shorter edge portions of the liquid crystal display panel 91. That is, the gate side common circuit boards 92 used are of one type, so that the number of types of the components does not increase, preventing an increase in production cost and an increase in product prices of the assembly 9.

The gate side common circuit board 92 used in the above-described assembly 9 needs to be structurally capable of being placed at either shorter edge portion of the liquid crystal display panel 91. To this end, bonding lands capable of being mounted with connectors used for connecting the gate side common circuit board 92 and the source side common circuit board 93 are provided in the vicinities of both ends of the gate side common circuit board 92. In a state where the gate side common circuit boards 92 are placed at both of the parallel shorter edge portions of the liquid crystal display panel 91, the connectors are mounted on the bonding lands adjacent to the source side common circuit boards 93, and the gate side common circuit boards 92 are electrically connected with the source side common circuit boards 93 via the connectors.

As prior art literatures relating to the present invention, Japanese Patent Application Unexamined Publications Nos. Hei04-295684 and 2002-9673 are cited.

However, in the assembly 9 structurally arranged as above, the bonding lands unadjacent to the source side common circuit boards 93 are not used, so that static electricity could enter through those unused bonding lands at the manufacturing stage of the assembly 9 or a display device incorporating the assembly 9, or at the stage of user's use. If static electricity enters through those unused bonding lands, the driver ICs 941 and 951 and various electronic and electrical components which are electrically connected with the bonding lands could be damaged by static electricity.

### SUMMARY OF THE INVENTION

In order to overcome the problems described above, preferred embodiments of the present invention provide a circuit board capable of preventing driver ICs and electronic and electrical components from being affected by static electricity, a liquid crystal display module having the same, and a display device having the same.

According to a first preferred embodiment of the present invention, a circuit board includes bonding lands each of which is capable of being mounted with an electrical connecting mechanism, which are placed at both ends in a longitudinal direction of the circuit board, wherein the bonding land placed at one of the ends of the circuit board is mounted with an electrical connecting mechanism, and a surface of the bonding land placed at the other end of the circuit board is covered with an electrical insulating coating.

According to a second preferred embodiment of the present invention, a liquid crystal display module includes a liquid crystal display panel, the circuit boards which are placed along two parallel edge portions of the liquid crystal display panel and a circuit board which is placed along one edge portion between the two parallel edge portions of the liquid crystal display panel, wherein the bonding lands of the circuit boards adjacent to the circuit board placed along the one edge portion between the two parallel edge portions of the liquid crystal display panel are mounted with the electrical connecting mechanisms, and are electrically connected with the circuit board placed along the one edge portion between the two parallel edge portions of the liquid crystal display panel, and the surfaces of the bonding lands placed at the other ends of the circuit boards are covered with the electrical insulating coating.

According to a third preferred embodiment of the present invention, a display device includes the circuit boards or the liquid crystal display module.

According to the preferred embodiments of the present invention, the plurality of bonding lands are selectively used and the bonding lands which are not used are covered with the electrical insulating coating, which can prevent static electricity from entering through the unused bonding lands. Accordingly, electronic and electrical components mounted on the circuit boards, and electronic and electrical components such as driver ICs which are incorporated into TCPs bonded to the circuit boards can be prevented from being affected by static electricity, to be more specific, can be prevented from being damaged or malfunctioning by static electricity.

Other features, elements, characteristics and advantages of the present invention will become more apparent from the following detailed description of preferred embodiments with reference to the attached drawings.

### BRIEF DESCRIPTION OF THE DRAWINGS

FIG. 1 is an external perspective view schematically showing the structure of a circuit board according to a first preferred embodiment of the present invention. In FIG. 1, partial enlarged views of portions A and B show the vicinities of both ends in a longitudinal direction of the circuit board.

FIG. 2 is an external perspective view schematically showing the structure of a liquid crystal display module according to a second preferred embodiment of the present invention, which includes the circuit boards according to the first preferred embodiment of the present invention.

FIG. 3 is a plan view schematically showing electrical connection configuration of the liquid crystal display module including the circuit boards.

FIG. 4 is an exploded perspective view schematically showing the structure of a display device according to a third preferred embodiment of the present invention, which incorporates the liquid crystal display module according to the second preferred embodiment of the present invention.

FIG. 5 is an exploded perspective view schematically showing the structure of a television receiver incorporating the display device according to the third preferred embodiment of the present invention.

FIG. 6 is an external perspective view schematically showing an example of the structure of a conventional liquid crystal display module.

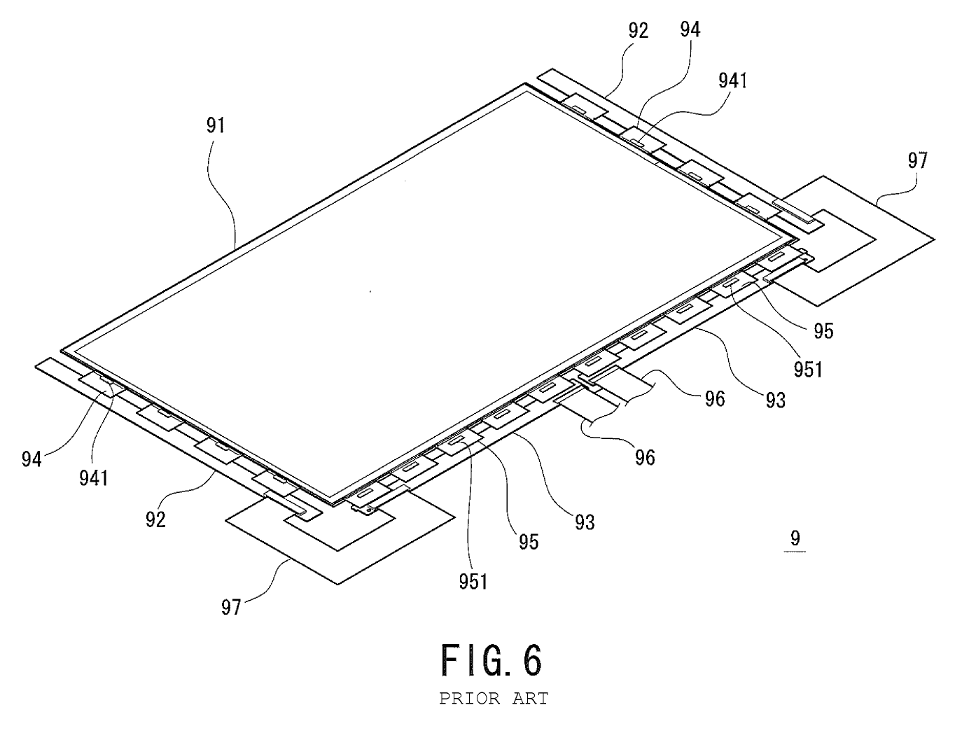

### DETAILED DESCRIPTION OF PREFERRED EMBODIMENTS

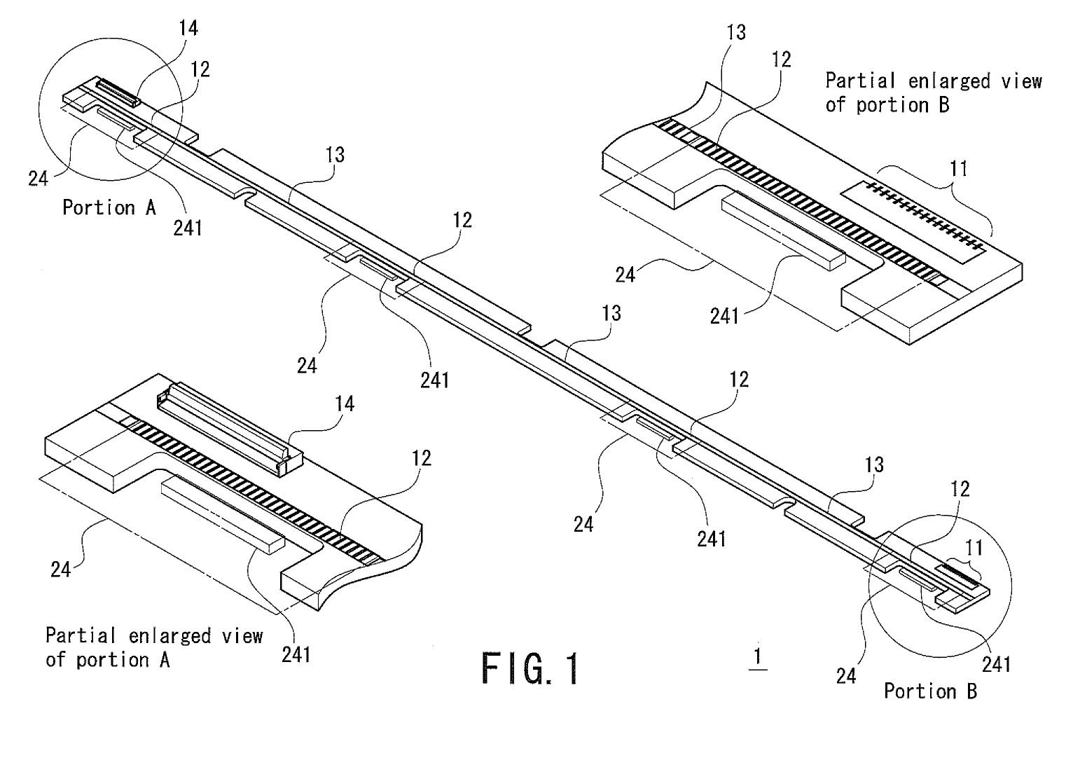

A detailed description of preferred embodiments of the present invention will now be given with reference to the accompanying drawings. FIG. 1 is an external perspective view schematically showing the structure of a circuit board according to a first preferred embodiment of the present invention. In FIG. 1, partial enlarged views of portions A and B show the vicinities of both ends in a longitudinal direction of the circuit board.

A circuit board 1 includes bonding lands 11 each of which is capable of being mounted with an electrical connecting mechanism 14, bonding lands 12 each of which is capable of being bonded to a TCP (Tape Carrier Package) 24 incorporating a driver IC and other components, and predetermined wires (not shown). The bonding lands 11 each capable of being mounted with the electrical connecting mechanism 14 and the bonding lands 12 each capable of being bonded to the TCP 24 are electrically connected with each other by the predetermined wires. Hence, the circuit board 1 can receive transmissions of predetermined incoming electric signals and power via the electrical connecting mechanism 14, and distribute the received predetermined electric signals and power to the bonding lands 12 via the predetermined wires.

The circuit board 1 has a long and narrow shape. The bonding lands 11 each capable of being mounted with the electrical connecting mechanism 14 are placed in the vicinities of both ends of the circuit board 1 (in the portions A and B respectively in FIG. 1)(note that the bonding land 11 is not shown in the partial enlarged view of the portion A in FIG. 1). In the present preferred embodiment of the present invention, an FPC connector is preferably used as the electrical connecting mechanism 14. Hereinafter, the bonding land 11 capable of being mounted with the FPC connector 14 is referred to as the “FPC connector bonding land 11” for the sake of illustration. For the FPC connector 14 to be mounted on the FPC connector bonding land 11, a variety of known FPC connectors can be used. Accordingly, a detailed description thereof is omitted.

The bonding lands 12 each capable of being bonded to the TCP 24 incorporating the driver IC 241 and other components are placed linearly at given intervals in a longitudinal direction of the circuit board 1. The TCPs 24 are to be bonded to the bonding lands 12 using an anisotropic conductive film (ACF) (not shown). Hereinafter, the bonding land 12 capable of being bonded to the TCP 24 is referred to as the “TCP bonding land 12” for the sake of illustration.

Dummy lands 13 are provided between the TCP bonding lands 12 in order to promote adhesion between the TCP bonding lands 12 and the ACF in attaching the ACF to the TCP bonding lands 12.

The predetermined wires are placed in parallel in the longitudinal direction of the circuit board 1.

The FPC connector bonding lands 11 are electrically connected with the predetermined wires. The TCP bonding lands 12 are electrically connected with the predetermined wires preferably via through-holes. Accordingly, the circuit board 1 can distribute the electric signals and power fed from the FPC connector bonding lands 11 to each of the TCPs 24 via the predetermined wires and the TCP bonding lands 12. Besides, the FPC connector bonding lands 11 placed in the vicinities of both ends of the circuit board 1 are arranged such that the electric signals and power can be fed from either of the FPC connector bonding lands 11.

In actual use, the FPC connector 14 is mounted on the FPC connector bonding land 11 in the vicinity of one of the ends of the circuit board 1 (in the portion A in FIG. 1), and predetermined incoming electric signals and power can be transmitted to the predetermined wires via an FPC (not shown) connected with the FPC connector 14.

No FPC connector is mounted on the FPC connector bonding land 11 in the vicinity of the other end of the circuit board 1 (in the portion B in FIG. 1), and a surface of the FPC connector bonding land 11 is covered with an insulating coating. For the insulating coating, a generally used insulating resin for a printed-circuit board such as silicon, an acrylic resin, urethane, epoxy and polyimide is preferably used.

Which FPC connector bonding land 11 is to be mounted with the FPC connector 14 is determined based on a usage state of the circuit board 1. In other words, while the circuit board 1 is provided with the FPC connector bonding lands 11 in the vicinities of its both ends, the FPC connector 14 is mounted on the FPC connector bonding land 11 which is actually used and the insulating coating is applied on the surface of the FPC connector bonding land 11 which is not used. Accordingly, in contrast with the structure of the circuit board 1 shown in FIG. 1, it is also preferable that the FPC connector 14 is mounted on the FPC connector bonding land 11 placed in the vicinity of the end in the portion B and the insulating coating is applied on a surface of the FPC connector bonding land 11 placed in the vicinity of the other end in the portion A. The specific usage state of the circuit board 1 will be described later.

The application of the insulating coating on the surface of the FPC connector bonding land 11 is preferably made in the course of application of an insulating coating to a wiring pattern and other components on the circuit board 1. By this, there is no need to add a process for applying the insulating coating to the FPC connector bonding land 11, so that the number of processes does not increase, which prevents an increase in production cost.

In addition, an insulating cover tape is preferably applied to the FPC connector bonding land 11 instead of applying the electrical insulating material thereto. For example, an insulating film made from vinyl chloride or other material is applied using an adhesive made from a sticky synthetic resin such as an acrylic resin. In this case, the cover tape may be applied so as to be easily detachable from the surface of the circuit board 1, or may be adhered thereto so as not to be easily detached.

The application of the insulating coating is not limited to the above-described examples. It is essential only that an electrical insulating material (including a material which has high electrical resistance and is accordingly regarded as substantially having electrical insulation properties) should be applied on the surface of the FPC connector bonding land 11 on which the FPC connector 14 is not mounted.

The circuit board 1 having the above-described structure can receive the transmissions of the predetermined incoming electric signals and power via the FPC (not shown) connected with the FPC connector 14, and distribute the received predetermined electric signals and power to each of the TCPs 24 via the predetermined wires and the TPC bonding lands 12.

Meanwhile, since the insulating coating is applied on the surface of the FPC connector bonding land 11 on which the FPC connector 14 is not mounted, static electricity can be prevented from entering through the FPC connector bonding land 11. Accordingly, electronic and electrical components such as the driver ICs 241 incorporated into the TCPs 24 can be prevented from being affected by static electricity, to be more specific, can be prevented from being damaged or malfunctioning by static electricity.

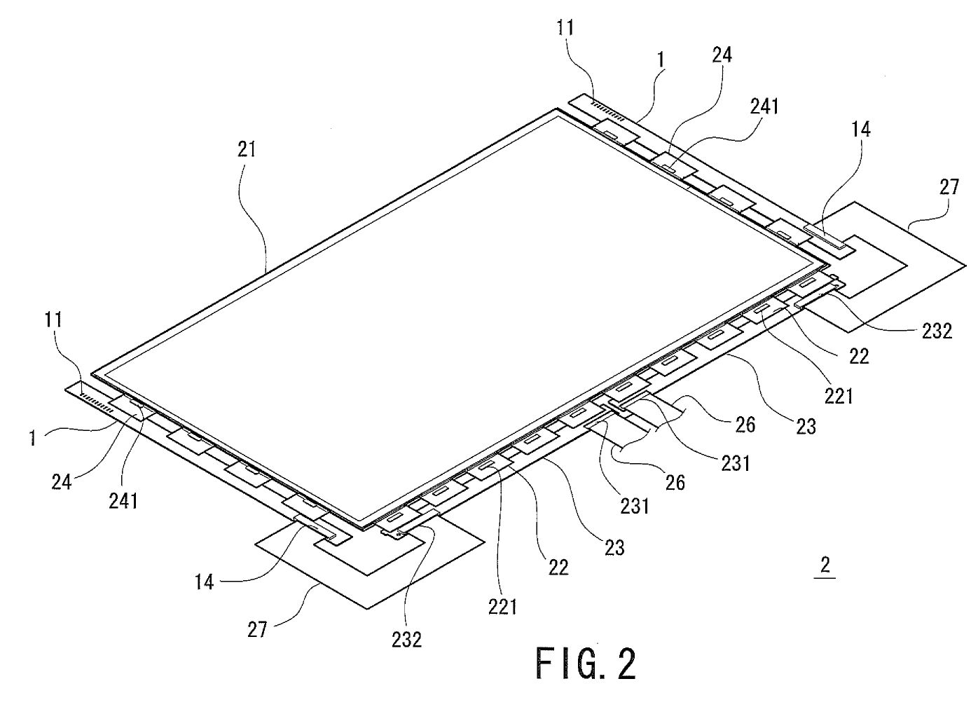

Next, a description of a liquid crystal display module according to a second preferred embodiment of the present invention which includes the circuit board 1 according to the first preferred embodiment of the present invention will be provided. FIG. 2 is an external perspective view schematically showing the structure of the liquid crystal display module including the circuit board 1.

A liquid crystal display module 2 includes a liquid crystal display panel 21, the plurality of TCPs 24 each incorporating the driver IC (scanning line electrode driver) 241, the circuit boards 1 capable of distributing predetermined electric signals and power to each of the TCPs 24, a plurality of TCPs 22 each incorporating a driver IC (signal line electrode driver) 221, circuit boards 23 capable of distributing predetermined electric signals and power to each of the TCPs 22.

Hereinafter, the TCP 24 incorporating the scanning line electrode driver 241 is referred to as the “gate TCP 24”, and the TCP 22 incorporating the signal line electrode driver 221 is referred to as the “source TCP 22” for the sake of illustration. In addition, the circuit board 1 capable of distributing the predetermined electric signals and power to the gate TCPs 24 is referred to as the “gate side common circuit board 1”, and the circuit board 23 capable of distributing the predetermined electric signals and power to the source TCPs 22 is referred to as the “source side common circuit board 23” for the sake of illustration.

As the liquid crystal display panel 21 included in the liquid crystal display module 2, a generally used active matrix type liquid crystal display panel is preferably used. The active matrix type liquid crystal display panel includes active elements such as thin film transistors each of which is formed in a pixel, scanning lines which transmit signals to gate electrodes of the thin film transistors in the pixels, and source signal lines which transmit signals to source electrodes of the thin film transistors in the pixels.

The plurality of source TCPs 22 are bonded at given intervals to one edge portion of the liquid crystal display panel 21 (to one of longer edge portions thereof in the present preferred embodiment of the present invention). In the present preferred embodiment of the present invention, the number of the source side common circuit boards 23 to which the source TCPs 22 are bonded is two. The number of source side common circuit boards 23 is not limited to two, and may be one or more than two.

The source side common circuit boards 23 have a long and narrow shape, and are arranged linearly along the longer edge portion of the liquid crystal display panel 21.

Each of the source side common circuit boards 23 includes predetermined wires (not shown) capable of transmitting the predetermined electric signals and power. The predetermined wires are arranged in parallel in longitudinal directions of the source side common circuit boards 23.

A bonding land (not shown) which is electrically connected with the predetermined wires is provided at one end of each of the source side common circuit boards 23 or in the vicinity of the end, the end being adjacent to the other source side common circuit board 23, and an FPC connector 231 is mounted on the bonding land. Hereinafter, the FPC connector 231 is referred to as the “first FPC connector 231” for the sake of illustration. The predetermined wires can receive transmissions of the predetermined incoming electric signals and power via FPCs 26 connected with the first FPC connectors 231.

A plurality of bonding lands (not shown) to which the source TCPs 22 are to be bonded are provided at given intervals on each of the source side common circuit boards 23. These bonding lands are electrically connected with the predetermined wires preferably via through-holes. The source TCPs 22 are bonded to these bonding lands using an ACF (not shown). Accordingly, the predetermined incoming electric signals and power can be distributed to each of the source TCPs 22 via the predetermined wires and the bonding lands.

The distributed predetermined electric signals and power put the signal line electrode drivers 221 incorporated into the source TCPs 22 into operation, and feed a current to the source electrodes of the thin film transistors which are on the source signal lines via the source signal lines in the liquid crystal display panel 21.

A bonding land (not shown) which is electrically connected with the predetermined wires is provided at the other end of each of the source side common circuit boards 23 or in the vicinity of the end, the end being adjacent to the gate side common circuit board 1, and an FPC connector 232 is mounted on the bonding land. Hereinafter, the FPC connector 232 is referred to as the “second FPC connector 232” for the sake of illustration. The second FPC connectors 232 and the FPC connectors 14 mounted on the gate side common circuit boards 1 are electrically connected with each other via FPCs 27. Hereinafter, the FPC 27 is referred to as the “second FPC 27” for the sake of illustration. Having the above-described structure, the source side common circuit boards 23 enable transmissions of the predetermined incoming electric signals and power to the gate side common circuit boards 1 via the predetermined wires and the second FPCs 27.

The gate side common circuit boards 1, i.e., the circuit boards according to the first preferred embodiment of the present invention, have the structure as described above. The gate side common circuit boards 1 are arranged such that longer edge portions thereof are opposed to shorter edge portions of the liquid crystal display panel 21. In each of the gate side common circuit boards 1 disposed along the shorter edge portions of the liquid crystal display panel 21, the FPC connector 14 is mounted on the FPC connector bonding land 11 adjacent to the source side common circuit board 23. The FPC connectors 14 and the second FPC connectors 232 mounted on the source side common circuit boards 23 are electrically connected with each other via the second FPCs 27.

The gate TCPs 24 incorporating the scanning line electrode drivers 241 are bonded to the TCP bonding lands 12 on the gate side common circuit boards 1.

Having the above-described structure, the gate side common circuit boards 1 can receive the transmissions of the predetermined incoming electric signals and power via the first FPCs 26, the source side common circuit boards 23 and the second FPCs 27, and distribute the transmitted predetermined electric signals and power to each of the gate TCPs 24 via the TCP bonding lands 12. The distributed predetermined electric signals and power put the scanning line electrode drivers 241 incorporated into the gate TCPs 24 into operation, and the scanning line electrode drivers 241 transmit signals on the scanning lines in the liquid crystal display panel 21 and drive the thin film transistors in the pixels on the scanning lines.

Incidentally, each of the gate side common circuit boards 1 is arranged such that a specific one of the parallel longer edge portions thereof is opposed to one of the shorter edge portions of the liquid crystal display panel 21. Accordingly, the gate side common circuit boards 1 placed along the shorter edge portions of the liquid crystal display panel 21 are different in their orientation by 180 degrees. In other words, the gate side common circuit boards 1 placed along the shorter edge portions of the liquid crystal display panel 21 are different from each other in which end is adjacent to the source side common circuit boards 23.

Among the FPC connector bonding lands 11 provided in the vicinities of both ends in the longitudinal directions of the gate side common circuit boards 1, the FPC connectors 14 are mounted on the FPC connector bonding lands 11 provided in the vicinities of the ends adjacent to the source side common circuit boards 23 while the surfaces of the FPC connector bonding lands 11 in the vicinities of the other ends are covered with the insulating coating.

In other words, before mounted with electronic and electrical components including the FPC connectors 14, the gate side common circuit boards 1 are identical with each other and can be placed without considering along which of the shorter edge portions of the liquid crystal display panel 21 the respective gate side common circuit boards 1 are to be placed. Then, at the stage of mounting the electronic and electrical components, the gate side common circuit boards 1 are made different from each other considering along which of the shorter edge portions of the liquid crystal display panel 21 the respective gate side common circuit boards 1 are to be placed. At this time, the surfaces of the unused FPC connector bonding lands 11 are covered with the insulating coating.

Having the above-described structure, the gate side common circuit boards 1 before being mounted with the electronic and electrical components are of only one type, which can prevent an increase in the number of types of the constituent elements. In addition, since the surfaces of the unused FPC connector bonding lands 11 are covered with the insulating coating, the electronic and electrical components can be prevented from being affected by static electricity through the unused FPC connector bonding lands 11.

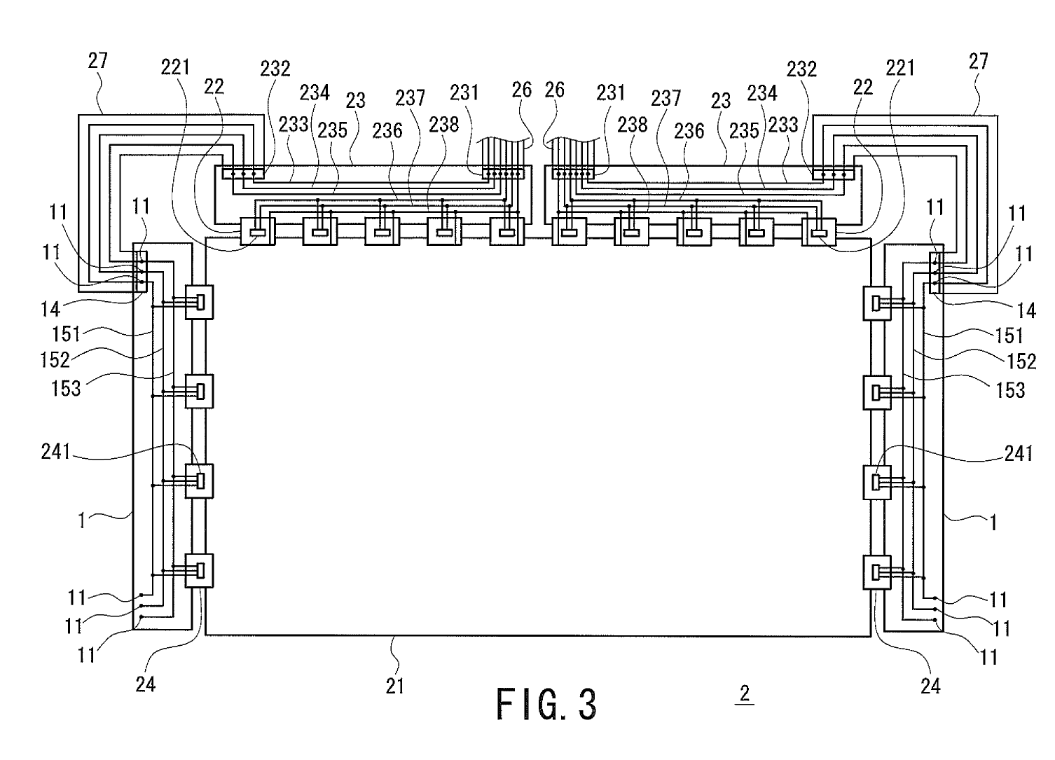

Next, descriptions of electrical connection configuration among the source side common circuit boards 23, the gate side common circuit boards 1, the source TCPs 22, the gate TCPs 24 and the liquid crystal display panel 21 will be provided. FIG. 3 is a plan view schematically showing the electrical connection configuration of these constituent elements.

As shown in FIG. 3, the first FPC connectors 231 are mounted in the vicinities of the opposed ends of the source side common circuit boards 23, and the source side common circuit boards 23 are connected with a given external circuit board (not shown), (e.g., a control circuit board) by the first FPCs 26, so that the source side common circuit boards 23 receive the transmissions of the predetermined incoming electric signals and power via the FPCs 26. The predetermined incoming electric signals and power include signals for controlling the signal line electrode drivers 221, driving power of the signal line electrode drivers 221, common voltages to be applied to the liquid crystal display panel 21, signals for controlling the scanning line electrode drivers 241, driving power of the scanning line electrode drivers 241, and auxiliary capacitances of the liquid crystal display panel 21.

The predetermined wires are arranged in parallel or substantially in parallel on the source side common circuit boards 23. The predetermined wires on the source side common circuit boards 23 include wires 236 which transmit the signals for controlling the signal line electrode drivers 221, wires 237 which transmit the power to be supplied to the signal line electrode drivers 221, wires 238 which transmit the common voltages to be applied to the liquid crystal display panel 21, wires 233 which transmit the signals for controlling the scanning line electrode drivers 241, wires 234 which transmit the power to be supplied to the scanning line electrode drivers 241, wires 235 which transmit the auxiliary capacitances to be supplied to auxiliary capacitance lines of the liquid crystal display panel 21, and spare wires for these wires (not shown).

The source side common circuit boards 23 are connected with the plurality of the source TCPs 22 incorporating the signal line electrode drivers 221. The signals for controlling the signal line electrode drivers 221, the driving power of the signal line electrode drivers 221 and the common voltages to be applied to the liquid crystal display panel 21 are distributed to each of the source TCPs 22 via the predetermined wires.

In addition, the second FPC connectors 232 are mounted at the opposite ends of the source side common circuit boards 23 or in the vicinities of these ends (i.e., the ends adjacent to the gate side common circuit boards 1), and the second FPC connectors 232 are electrically connected with the FPC connectors 14 mounted on the gate side common circuit boards 1 via the second FPCs 27.

The predetermined wires are arranged in parallel or substantially in parallel on the gate side common circuit boards 1. The predetermined wires on the gate side common circuit boards 1 include wires 151 which transmit the signals for controlling the scanning line electrode drivers 241, wires 152 which transmit the power to be supplied to the scanning line electrode drivers 241, wires 153 which transmit the auxiliary capacitances to be supplied to the auxiliary capacitance lines of the liquid crystal display panel 21, and spare wires for these wires (not shown).

These wires are electrically connected with the FPC connector bonding lands 11 placed at both ends of the gate side common circuit boards 1. As described above, the FPC connectors 14 are mounted on the FPC connector bonding lands 11 adjacent to the source side common circuit boards 23 while the surfaces of the FPC connector bonding lands 11 unadjacent to the source side common circuit boards 23 are covered with the insulating coating.

The gate side common circuit boards 1 are connected with the plurality of the gate TCPs 24 incorporating the scanning line electrode drivers 241.

The predetermined wires of the source side common circuit boards 23 and the predetermined wires of the gate side common circuit boards 1 are electrically connected with each other via the second FPCs 27. These electrically connected predetermined wires include the wires 233 and the wires 151 which transmit the signals for controlling the scanning line electrode drivers 241, the wires 234 and the wires 152 which transmit the power to be supplied to the scanning line electrode drivers 241, the wires 235 and the wires 153 which transmit the auxiliary capacitances to be supplied to the auxiliary capacitance lines of the liquid crystal display panel 21, and the spare wires for these wires (not shown).

The signals for controlling the scanning line electrode drivers 241, the driving power of the scanning line electrode drivers 241 and the auxiliary capacitances of the liquid crystal display panel 21 are transmitted to the gate side common circuit boards 1 via the first FPCs 26, the source side common circuit boards 23 and the second FPCs 27, and then are distributed to each of the gate TCPs 24 on the gate side common circuit boards 1.

According to the above-described electrical connection configuration, the predetermined incoming signals and power put the signal line electrode drivers 221 and the scanning line electrode drivers 241 into operation, and the signal line electrode drivers 221 and the scanning line electrode drivers 241 drive the thin film transistors in the liquid crystal display panel 21.

Next, a description of a display device according to a third preferred embodiment of the present invention which includes the liquid crystal display module 2 according to the second preferred embodiment of the present invention will be provided.

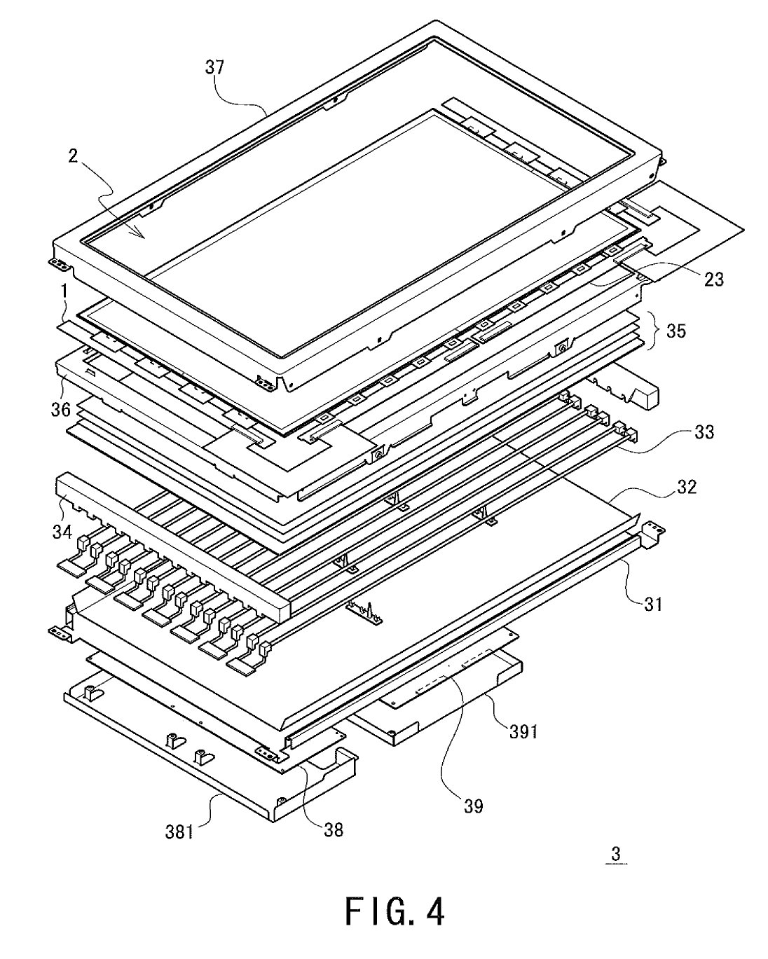

FIG. 4 is an exploded perspective view schematically showing the structure of the display device including the liquid crystal display module 2. Incidentally, in FIG. 4, the display device is shown so that its front surface faces toward the top of FIG. 4, and its back surface faces toward the bottom of FIG. 4, based on which the description will be provided.

A display device 3 includes the liquid crystal display module 2, a backlight chassis 31, light sources 33, a reflection sheet 32, optical sheets 35, side holders 34, a frame 36, a bezel 37, a control circuit board 39, and a light source driving circuit board 38.

Brief descriptions of these constituent elements will be provided. The backlight chassis 31 is a member substantially in the shape of a square plate, which is preferably molded by subjecting a metal plate material to press working.

For the light sources 33, fluorescent tubes such as hot/cold cathode tubes, light-emitting diodes, other various light sources, and combinations thereof are preferably used. In FIG. 4, a plurality of linear fluorescent tubes are used.

The reflection sheet 32 is a member in the shape of a sheet or a plate arranged to diffusely reflect light emitted from the light sources 33, which is preferably made from an expanded PET (polyethylene terephthalate) material.

The optical sheets 35 are members in the shape of a sheet or a plate, or a set of the members, which are arranged to control the properties of the light emitted from the light sources 33. To be more specific, the optical sheets 35 define a stack of a diffusion plate, a lens sheet and a polarizing reflection sheet.

The side holders 34 are members substantially in the shape of a bar, which are preferably made of a resin material and unitary molded, and define spacers on which the optical sheets 35 are placed.

The frame 36 is a member in the shape of a square with an opening, which is provided with side walls on its edges which extend toward the back surface of the display device 3. The frame 36 is preferably made of a metal plate material by being subjected to press working, and holds and secures the light sources 33, the optical sheets 35 and other members to the backlight chassis 31.

The bezel 37 is a member preferably in the shape of a square with an opening, which is preferably made of a metal plate material by being subjected to press working, and holds and secures the liquid crystal display module 2 and other members to the frame 36.

The light source driving circuit board 38 incorporates electronic circuits and electric circuits arranged to drive the light sources 33. The control circuit board 39 incorporates electronic circuits and electric circuits which produce the various electric signals for controlling the liquid crystal display module 2.

Incidentally, for the backlight chassis 31, the light sources 33, the reflection sheet 32, the optical sheets 35, the side holders 34, the frame 36, the bezel 37, the control circuit board 39 and the light source driving circuit board 38, conventional members are preferably used. Accordingly, detailed descriptions thereof are omitted.

The display device 3 including the above-described constituent elements is assembled as follows. The reflection sheet 32 is laid on a front surface of the backlight chassis 31, and the light sources 33 are placed on a front surface of the reflection sheet 32. In this state, the side holders 34 are attached to shorter edge portions of the backlight chassis 31. The optical sheets 35 are placed on the front surfaces of the chassis 31 and the side holders 34, and the frame 36 is further placed in front of the optical sheets 35.

The liquid crystal display module 2 is placed on a front surface of the frame 36, and the gate side common circuit boards 1 and the source side common circuit boards 23 included in the liquid crystal display module 2 are bent toward the back surface of the display device 3, and are secured to the side walls of the frame 36. The bezel 37 is placed on a front surface of the liquid crystal display module 2.

The control circuit board 39 and the light source driving circuit board 38 are placed behind the backlight chassis 31, and a control circuit board cover 391 and a light source driving circuit board cover 381 are attached thereto respectively so as to cover them. The control circuit board 39 and the source side common circuit boards 23 are connected by the first FPCs (not shown) so as to enable the transmittance and reception of the electric signals. Harnesses extending from the light sources 33 are connected with the light source driving circuit board 38.

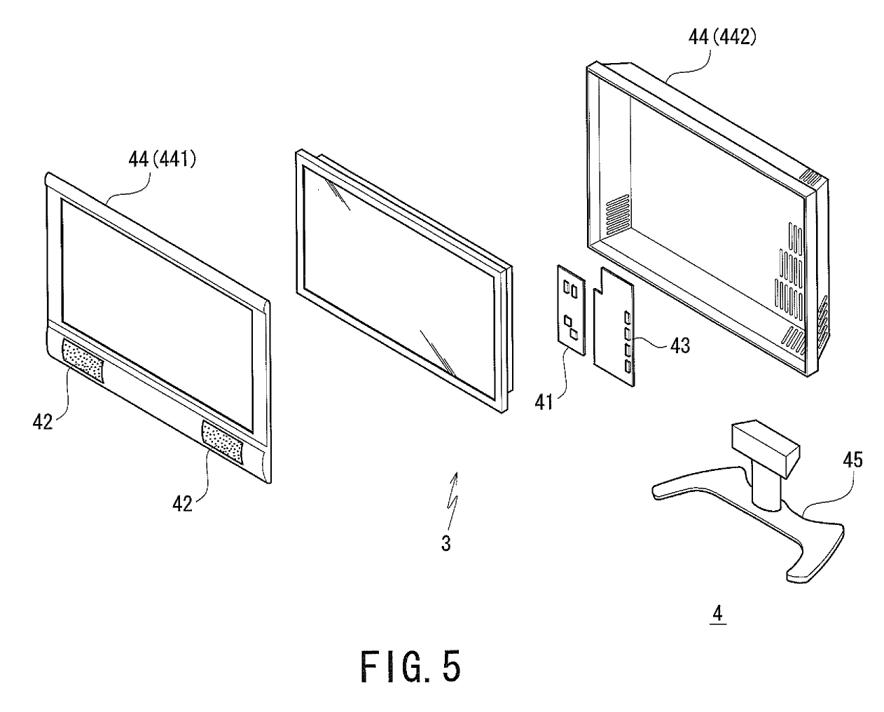

FIG. 5 is an exploded perspective view schematically showing the structure of a television receiver incorporating the display device 3. A television receiver 4 shown in FIG. 5 includes the display device 3, a tuner 41, loudspeaker mechanisms 42, an electric power supply board 43, a cabinet 44, and a stand 45.

The tuner 41 is a circuit board incorporating a circuit which produces an image signal and a sound signal of a given channel based on received radio waves or signals inputted from the outside. For the tuner 41, one or more than one of a conventional terrestrial tuner (analog and/or digital), a BS tuner, and a CS tuner can be preferably used.

The loudspeaker mechanisms 42 produce a sound based on the sound signal produced by the tuner 41. For the loudspeaker mechanisms 42, conventional loudspeaker mechanisms such as generally-used loudspeakers can be preferably used.

The electric power supply board 43 supplies electric power to the display device 3, the tuner 41, and the loudspeaker mechanisms 42.

As shown in FIG. 5, the display device 3, the tuner 41, the loudspeaker mechanisms 42 and the electric power supply board 43 are housed in the cabinet 44 which is supported by the stand 45. In FIG. 5, the cabinet 44 includes a front side cabinet 441 and a back side cabinet 442, and the display device 3 and other constituent elements are housed therebetween.

While preferred embodiments of the present invention have been described above, it is to be understood that variations and modifications will be apparent to those skilled in the art without departing the scope and spirit of the present invention.

For example, although the FPC is used as the electrical connecting mechanism for the source side common circuit board and the gate side common circuit board in the above-described preferred embodiments of the present invention, an FFC and other kinds of cables can be used instead of the FPC.

In addition, the electrical connection between the source side common circuit board and the gate side common circuit board is not limited to the combination of the FPC connector and the FPC. An FFC and other kinds of cables can be used instead of the FPC, and soldering can be used instead of using the connector.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-3. (canceled)

4. A circuit board comprising:
bonding lands each of which is capable of being mounted with an electrical connecting mechanism, which are located at both ends in a longitudinal direction of the circuit board; wherein
the bonding land disposed at one of the ends of the circuit board is mounted with an electrical connecting mechanism, and a surface of the bonding land placed at the other end of the circuit board is covered with an electrical insulating coating.

5. A liquid crystal display module comprising:
a liquid crystal display panel;
at least two circuit boards according to claim 4 disposed along two substantially parallel edge portions of the liquid crystal display panel; and
a circuit board disposed along one edge portion between the two substantially parallel edge portions of the liquid crystal display panel; wherein
the bonding lands of the circuit boards according to claim 4 adjacent to the circuit board placed along the one edge portion between the two substantially parallel edge portions of the liquid crystal display panel are mounted with the electrical connecting mechanisms, and are electrically connected with the circuit board disposed along the one edge portion between the two substantially parallel edge portions of the liquid crystal display panel; and
the surfaces of the bonding lands disposed at the other ends of the circuit boards are covered with the electrical insulating coating.

6. A display device comprising at least one circuit board according to claim 4.

7. A display device comprising the liquid crystal display module according to claim 5.
